(19) United States
(12) Patent Application Publication
(10) Pub. No.: US 2010/0257109 A1
(43) Pub. Date: Oct. 7, 2010

(54) System and Method for Associating Documents in a Transaction with Transaction Data

(75) Inventors: Joseph Thomas Malleis, Grand Rapids, MI (US); Keith McCreery, Rockford, MI (US)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: Compliance Systems, Inc.

(21) Appl. No.: 12/749,786

(22) Filed: Mar. 30, 2010

Related U.S. Application Data
(60) Provisional application No. 61/165,706, filed on Apr. 1, 2009.

(51) Int. Cl. G06Q 99/00; G06Q 40/00; G06Q 10/00; G06F 17/30

(52) U.S. Cl. 705/317; 705/342; 707/802; 707/E17.044

(57) ABSTRACT

Various methods and systems for generating a transaction document used in a transaction are provided. For example, the method may include generating a plurality of potential transaction documents, at least one of which is to be used in the transaction. The method may further include creating one or more associations that relate the potential transaction document to be used in the transaction to transaction information used in the transaction. The method may further include receiving the transaction information, storing the transaction information in a uniform hierarchical format, selecting the potential transaction document to be used in the transaction, and rendering the transaction document based on the transaction information in the uniform hierarchical format, the one or more associations, and the selected potential transaction document to be used in the transaction.

### CROSS-REFERENCE TO RELATED APPLICATIONS

This application claims priority to U.S. Provisional Patent Application Ser. No. 61/165,706, filed Apr. 1, 2009, which is hereby incorporated by reference herein in its entirety.

### FIELD OF THE INVENTION

The invention relates to systems and methods for associating documents in a transaction with transaction data.

### BACKGROUND OF THE INVENTION

Individuals, businesses, government, and other parties execute a wide variety of transactions. These transactions are often documented or papered with various transaction documents, including but not limited to contracts, agreements, disclosures, schedules, and/or other transaction documents. Transactions may have a variety of transaction types including, but not limited to, deposit accounts, Individual Retirement Accounts, consumer lending, commercial lending, mortgages, and other transaction types. Each transaction may involve various types of transaction activities such as opening an account, applying for a loan, dealing with government regulations, or other transaction activities. Automated processes for completing a transaction activity may require gathering transaction information associated with the transaction and populating transaction documents with the transaction information. Representing, compiling, transmitting, processing, and/or retrieving transaction information may make the gathering process time consuming and expensive.

Often one type of transaction may require some transaction information that is similar, and possibly identical, to transaction information required by another type of transaction; whereas some transaction information may be entirely different between two types of transactions. For example, a party may be involved in a consumer lending contract with a commercial lender that requires transaction information relating to the regulatory environment affecting the contract. The same party may also be involved in a commercial lending contract with a commercial lender that may not require any transaction information relating to the regulatory environment. Here, the consumer lending contract and the commercial lending contract may have some similar transaction information such as the identity of the party and some different transaction information such as transaction information relating to the regulatory environment.

The transaction documents may include transaction information in separate documents or include transaction information in the same document, in either case in one or more formats. This may also make representing, transmitting, processing, and/or retrieving transaction information problematic.

Because various categories of transaction information may be loosely defined by transaction documents, transaction information representing a certain regulation that affects a contract, for example, may not be categorized as transaction information related to a particular regulatory environment. Thus, only those familiar with the contract may be able to identify the transaction information as pertinent to the regulatory environment. This may also make storage, compilation, and retrieval of this transaction information problematic.

Many types of transactions require the same or similar transaction information yet use different terms or data fields to define, describe, reference, organize and/or store the data. In some cases, the same or similar transaction information may be stored in data fields having different names. For example, an identity of a person applying for a loan may be referred to in a data field called “borrower” in a loan application, a data field called “mortgagor” in a mortgage application, and a data field called “account holder” in a deposit or retirement account document.

Furthermore, a particular transaction may require transaction information that is redundant. For example, a loan application may require the identity of the borrower applying for a loan as well as the identity of the account holder who is putting up collateral for the loan even though the borrower and the account holder are the same person. In this case, existing systems and methods may require entering information related to the identity of the loan applicant (among other information related to the loan applicant) and the identity of the account holder (among other information related to the account holder) even though the entered information is the same. Thus, the identity of the person, for example, is made redundant in existing transaction data schemas. Additionally, a loan processor, for example, would have to redundantly enter this data, increasing the chances for error. These problems often lead to inefficiencies, making representing, transmitting, processing, and/or retrieving transaction information problematic.

In some transactions, the same transaction document may be used multiple times although populated with different transaction information. For example, some transactions may require multiple powers of attorney or multiple loan applications. In existing systems, users submit transaction information along with each of copy of the transaction document. As a result, focus is placed on individual transaction documents rather than the transaction itself or the underlying transaction information. This may lead to inefficiencies and redundancies in processing and generating transaction documents.

These and other problems often persist because existing systems and methods focus on transaction documents for the transaction information instead of focusing on the transaction information itself. Lending institutions, for example, may store and rely upon loan application documents instead of the underlying transaction information and relationships described therein. As a result, transactions of one type are typically represented independently of transactions of another type, which makes using transaction information from one transaction to another difficult even though they often share similar information.

Existing systems and methods suffer from these and other problems.

### SUMMARY OF THE INVENTION

The invention relates to systems and methods for providing an improved data schema for representing, transmitting, processing, and/or retrieving information for a variety of transactions. According to various implementations of the invention, transaction information may be received and represented in a hierarchical data structure. The hierarchical data structure may include some or all transaction information that is required to complete one or more transaction documents related to a transaction. As such, the hierarchical data structure may be used to automatically populate standard transaction documents with the transaction information necessary to document or paper a transaction.

According to various implementations of the invention, the data schema may organize the transaction information into one or more information categories. The one or more information categories may be used to efficiently organize the transaction information to facilitate completing the transaction. The information categories may reflect real-world use and application of the transaction information. In other words, the data schema focuses on the underlying transaction information rather than the transaction documents.

According to various implementations of the invention, the one or more information categories into which transaction information is organized may include, for example, Entities, Underwriting, Collateral, Terms and Provisions, Regulatory, Administrative, and/or other information categories. The Entities category may describe parties involved in, associated with or related to a transaction. The Underwriting category may describe criteria affecting the transaction, such as criteria affecting whether to extend credit for a loan application, for example. The Collateral category may describe collateral that is used to secure the transaction. The Terms and Provisions category may describe terms and provisions related to the transaction. The Regulatory category may describe information related to the regulatory environment of the transaction, including but not limited to federal, state, and/or local disclosure requirements for example. The Administrative category may describe administrative rules, such as institution specific rules, related to the transaction.

According to various implementations of the invention, the one or more categories may define a top level of the hierarchical data structure for transaction information.

According to various implementations of the invention, the hierarchical data structure may include one or more data elements. The data elements may describe data related to the transaction. The data elements may be part of or be categorized in an applicable category. Data elements may include other data elements that are nested and further describe or pertain to the parent data element. In this sense, one data element may describe another data element. According to various implementations of the invention, data elements may also be combined or otherwise used together to enrich transaction information.

According to various implementations of the invention, the data elements may include an “entity” data element. The entity data element describes a party, such as a mortgage applicant, related to the transaction, such as a mortgage.

According to various implementations of the invention, the data elements may include a “role” data element. The role data element may describe a role played by another data element. For example, a mortgage applicant who has an Entity Type “Individual” may have a role of “Borrower” in a transaction related to a mortgage application.

According to various implementations of the invention, the data elements may include an “Entity Type” data element. An Entity Type describes a type of entity such as, for example, “Individual,” “Corporation,” or other type of entity. The Entity Type may help identify and/or classify an entity involved in a transaction.

According to various implementations of the invention, the data elements may include a “location use code” data element. A location use code is used to relate location information of a data element. For example, location information for an entity of Entity Type “Individual” described by a location use code “Primary” indicates that the location information relates to a primary mailing address for the entity.

According to various implementations of the invention, when nested and combined with other data elements, transaction information may be controlled by restricting or allowing combinations of data elements. For example, certain combinations of roles and Entity Types may be restricted. An entity described by Entity Type “Individual” may not be described by a role of “FinancialInstitutionBranch,” for example, because an individual would not be described as having this role. Furthermore, according to various implementations of the invention, certain combinations of roles and Entity Types may be permissibly allowed. In various implementations of the invention, certain combinations of roles and Entity Types may be mandatory when certain roles or certain Entity Types are used. As another example, use of a location use code may vary depending on the entity associated with the location use code. Furthermore, use of particular location use codes may be restricted to certain roles of an entity. For example, location use code “PrincipalResidence” may be restricted to Entity Type “Individual.” Furthermore, location use code “PrincipalResidence” may be further restricted to Entity Type “Individual” if the entity has a role of “Borrower.” Other restrictions and allowances are contemplated.

According to various implementations of the invention, a data element may be used to reduce the redundancy of transaction information for a transaction. The result is a many-fold reduction in the number of data points that is mapped to by users of the hierarchical data structure and a concomitant reduction in the number of data that is entered by a party when processing and/or executing a transaction. For example, data entered by a financial institution may be minimized when processing a transaction such as originating a new loan, opening a new account, and/or other transaction.

For example, roles may be used, inter alia, to reduce the number of data points that are mapped to by a financial institution or other entity using the hierarchical data structure. A transaction may require certain data related to the parties to the transaction to be captured and processed. Such data often includes, for example, an identity of a party, street address, city address, state address, zip code, various phone numbers, and/or other data. Furthermore, each party may serve various roles in the transaction. For example, a party may be the applicant, who is also the borrower, who, in turn, is also the mortgagor. According to various implementations of the invention, instead of redundantly storing/capturing information related to the applicant, borrower, and mortgagor, this information is captured once by using roles. The role data element, for example, may reduce the transaction information associated with the entity data element. In this example, the applicant, borrower, and mortgagor are assigned an entity ID. The role data element is not limited to the entity data element. Various collaterals, for example, may serve one or more roles within a credit transaction. Other data elements may similarly be used to streamline the hierarchical data structure.

According to various implementations of the invention, the hierarchical data structure may represent the transaction information in a uniform manner. Therefore, transaction information from one transaction may be compiled, stored, and retrieved for use in another transaction that would otherwise refer to the transaction information differently. In other words, various implementations of the invention may enable transaction information related to one transaction to be used with another transaction having the same or different type. Transaction information may be received from a variety of sources of information related to transactions such as from transaction documents, transactions databases, transaction forms, and/or other sources of transaction information. Transactions may be related to, for example, deposit accounts, retirement accounts, consumer lending, commercial lending, mortgage, and/or other transactions. Transaction information may include, for example, the identity of a person applying for a loan, personal information of the person, the identity of a banking institution making a loan, employer identification of the banking institution, and/or any other transaction information.

For example, the identity of an account holder for a deposit account may be referred to as an “account holder.” The transaction information related to the deposit account (including the identity of the account holder) may be received and uniformly stored. The account holder may subsequently apply for a mortgage. Execution of the transaction related to the mortgage application may include generating a mortgage application document. A lending institution may identify a mortgage applicant on a mortgage application document as “Borrower.” Uniform storage of the identity of the account holder enables executing a transaction related to the mortgage application even though the mortgage application may identify the account holder as “Borrower,” for example. Accordingly, transaction information from the deposit account identifying the “account holder” may be used to identify the individual applying for the mortgage as “borrower” in the mortgage application document. Other examples are contemplated. For example, transactions may be the same type of transaction but refer to transaction information differently. A first mortgage transaction may refer to the identity of a borrower as “applicant” while a second mortgage transaction may refer to the identity of a borrower as “borrower.”

According to various implementations of the invention, the hierarchical data structure may be used to ensure transaction information that is required for a particular transaction document is included in the transaction document. The hierarchical data structure may account for the transaction information that is required by facilitating validation of transaction information stored therein. In this manner, transaction information that is required for a particular transaction document may not be overlooked. On the other hand, transaction information that is irrelevant to the particular transaction document may be omitted from the transaction document.

For example, parties may efficiently exchange transaction information with one another because transaction information for the hierarchical data structure may be validated. In this manner, transaction information related to a transaction document received from a party that has different transaction information requirements may be efficiently exchanged even though the parties have different transaction information requirements. One party may rapidly identify missing transaction information from the hierarchical data structure that is required by that party but is not required by another party, for example.

In particular, a lending institution may use a mortgage application document that requires transaction information that describes a borrower's education level. If transaction information that describes the borrower's education level was not received, for example, transaction information for the mortgage application document may not be validated. In this manner, a loan officer for the lending institution that successfully generates a mortgage application document based on transaction information from the hierarchical data structure may be confident that transaction information requirements for the mortgage application have been met.

According to various implementations of the invention, parameters for validation of transaction information may be updated. In this manner, even if transaction information requirements for a transaction document are changed, validation may be updated in substantially real-time. Parties may create new transaction information requirements while using transaction information from the hierarchical data structure that was received before the new transaction information requirements.

According to various implementations of the invention, the hierarchical data structure may facilitate identification of transaction documents that are required for a particular transaction. For example, processing a mortgage loan may involve generating a mortgage application document as well as truth-in-lending disclosure documents. The hierarchical data structure may facilitate identification of these requirements and enable efficient processing of the mortgage.

In operation, parties may use the hierarchical data structure to efficiently exchange transaction information for diverse types of transactions. For example, a lending institution may be a party to a lending contract. The lending institution may use the hierarchical data structure to order transaction documents related to regulatory issues associated with the contract. A residential unit of the lending institution may use the hierarchical data structure to order mortgage application documents related to mortgage transactions. Likewise, a corporate lending unit of the lending institution may use the hierarchical data structure to order commercial lending documents related to commercial loans. Here, the deposit account, mortgage, and commercial loan may each have different transaction information requirements. According to various implementations of the invention, the same, single, hierarchical data structure nonetheless enables efficient storage and use of transaction information from these and other types of financial transactions.

Furthermore, parties may use the hierarchical data structure to efficiently exchange transaction information even though the transaction information is received from parties that store transaction information differently from one another. For example, a lending institution may wish to purchase a standard set of transaction documents for interfacing with a variety of other lending institutions that each have different transaction formats and/or content for the transaction documents. In this manner, the lending institution may avoid the time and expense of parsing each of the transaction documents from the other lending institutions.

Transaction information may be from a broad variety of types of transactions. Transaction information may also be differently stored depending on the party storing them. Nonetheless, the hierarchical data structure enables efficient storage and usage of the transaction information stored therein. The hierarchical data structure provides a single data schema for documenting transactions between a customer and a financial institution throughout a variety of localities, allowing single integration of transaction information regardless of local practices. The single integration allows for a financial institution or other party integrating to the data schema to originate consumer loans, commercial loans, portfolio mortgages, conforming mortgages, home equity loans, deposit accounts, retirement or other tax favored deposit accounts, and/or other transactions without the need for multiple, expensive and time-intensive integrations. For example, via the use of roles, data identifying parties to a transaction may be mapped to by the integrating party only once. Thereafter, the same data may be used within all areas of the financial institutions simply by applying different roles and uses to the same data and associating via ID references.

According to various implementations of the invention, transaction information is collected for each party to a transaction and/or to each item of collateral related to the transaction. In addition, during a document selection process, the transaction documents required to effect the transaction are identified and selected. In selecting the transaction documents, various ones of the transaction documents may be associated with one or more entities and/or one or more items of collateral for the transaction (e.g., borrower, account, etc.). When the transaction documents are rendered, the transaction documents may be populated with the proper transaction information for one or more entities and/or one or more items of collateral.

Other objects and advantages of the invention will be apparent to those skilled in the art based on the following drawings and detailed description.

### BRIEF DESCRIPTION OF THE DRAWINGS

FIG. 1 illustrates a block diagram of an exemplary system for representing various transactions according to various implementations of the invention.

FIG. 2 illustrates a block diagram of an exemplary computing device for representing various transactions according to various implementations of the invention.

FIG. 3 illustrates a block diagram of an exemplary hierarchical data structure categorizing transaction information according to various implementations of the invention.

FIG. 4 illustrates a block diagram of an exemplary category of transaction information within an exemplary hierarchical data structure representing transaction information according to various implementations of the invention.

FIG. 5 illustrates a flow diagram of an exemplary method for categorizing transaction information according to various implementations of the invention.

FIG. 6 illustrates a flow diagram of an exemplary method for representing various transactions according to various implementations of the invention.

FIG. 7 illustrates a system that may be used to generate transaction documents for a transaction according to various implementations of the invention.

FIG. 8 illustrates a process for generating transaction documents for a transaction according to various implementations of the invention.

### DETAILED DESCRIPTION

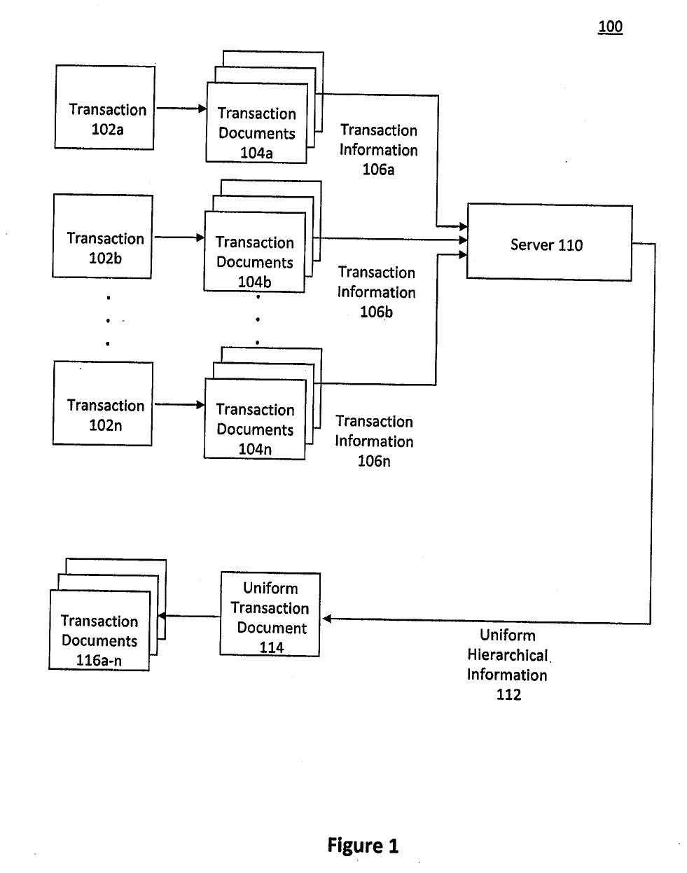

FIG. 1 illustrates an exemplary transaction information system 100 that may provide a framework for representing various transactions 102 (illustrated in FIG. 1 individually as a transaction 102a, a transaction 102b, and a transaction 102n) according to various implementations of the invention. Transactions 102 may be related to deposit accounts, retirement accounts, consumer lending, commercial lending, mortgage, and/or other types of transactions. Transactions 102 typically are documented with or “papered by” or otherwise depend upon, one or more transaction documents 104 (illustrated in FIG. 1 as transaction documents 104a, transaction documents 104b, and transaction documents 104n) according to various implementations of the invention. Transaction documents 104 may be any document related to process, complete, memorialize, or otherwise use for transactions 102. For example, transaction documents 104 may include a mortgage application, a deposit account document, a contract, disclosure documents, and/or other transaction documents 104 depending on the type of transaction 102 associated therewith. A mortgage application, for example, may have a different format than a deposit account document. Furthermore, depending upon the institution or industry, one transaction, such as transaction 102a that is the same type as another may have different transaction documents 104. For example, one mortgage application may have a different format than another mortgage application.

Transaction documents 104 may include corresponding transaction information 106 (illustrated in FIG. 1 as transaction information 106a, transaction information 106b, and transaction information 106n) according to various implementations of the invention. Transaction information 106 includes data that is related to transactions 102. As mentioned, this transaction information 106a for transaction documents 104a may be in the same or different formats from transaction information 106b for transaction documents 104b even though transaction information 106a and transaction information 106b are substantially the same. Furthermore, transaction information 106a from transaction document 104a may be referred to differently than transaction information 106b from transaction document 104b even though transaction information 106a and transaction information 106b are substantially the same.

For example, when a transaction 102 includes a mortgage transaction, transaction documents 104 may include a mortgage application. The mortgage application may refer to certain transaction information 106 such as a “Borrower” in reference to an individual seeking the mortgage. When a transaction 102 includes a deposit account, transaction documents 104 may include a deposit account document. The deposit account document may refer to certain transaction information 106 such as an “Account Owner” in reference to an individual owning the deposit account. In some cases, the individual may be the same person despite being referred to as “Borrower” with respect to the mortgage transaction and as “Account Owner” with respect to the deposit account transaction. Even though the two transactions likely share some content (e.g., an identity of the individual), the transaction information 106 may represent that content in a different format or use entirely different content between the two transactions.

According to various implementations of the invention, server 110 may receive transaction information 106. Server 110 may process the received transaction information 106 as discussed in further detail below. According to various implementations of the invention, server 110 may render uniform hierarchical information 112 based on the processed transaction information 106. Uniform hierarchical information 112 may be used to generate uniform transaction document 114.

According to various implementations of the invention, uniform transaction document 114 may use a format that is capable of representing uniform hierarchical information 112. Such a format may include, for example, Extensible Markup Language (XML), tab-delimited text, comma-separated value file, or other format suitable to represent the hierarchical data structure.

According to various implementations of the invention, uniform transaction document 114 may include some or all data necessary to complete, process, or otherwise use with transactions 102. As such, uniform transaction document 114 may be used generate or populate one or more transaction documents 116. Uniform transaction document 116a-n may represent, for example, a mortgage application transaction, and/or other type of transaction. In this manner, uniform transaction documents 116 may correspond to or include substantially the same content or format as transaction documents 104. In this manner, instead of representing various different transaction information 106 in various different transaction documents 104, which each may contain different content or format from one another, transaction information 106 may be represented by uniform transaction document 114, which may take into account the various differences among transaction documents 102.

It should be understood that server 110 may be any hardware or software-enabled hardware component suitable to carry out features and functions according to various implementations of the invention.

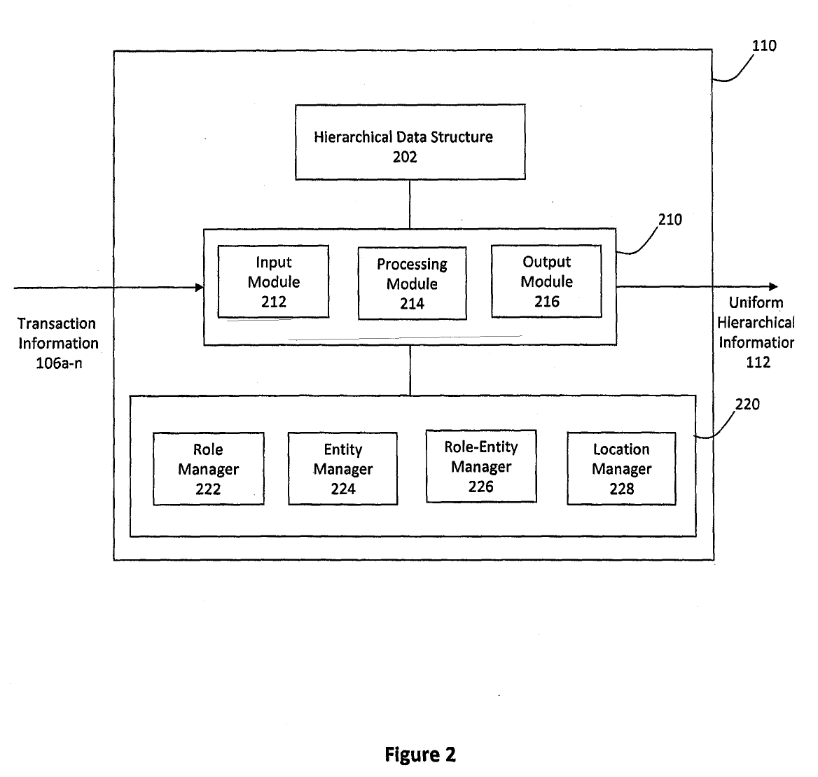

According to various implementations of the invention, as illustrated in FIG. 2, for example, server 110 may include an input module 212 for receiving transaction information 106. Transaction information 106 may be received or derived from a variety of sources of transaction documents 102.

As discussed above, transaction information 106a from transaction documents 102a may include different content or have content in different formats compared to transaction information 106b from other transaction documents 102b. According to various implementations of the invention, input module 212 may account for these and other differences using one or more translation modules (not otherwise illustrated). Alternatively or additionally, input module 212 may receive data that has already been translated. For example, the one or more translation modules may each be specific to a particular one of transactions 102 (e.g., transaction 102a) being processed. Thus, the one or more translation modules may function as adaptors that account for the various differences among different transaction information 106. On the other hand, input module 212 may receive data that has already been translated.

According to various implementations of the invention, once received, the data in received transaction information 106 may be processed. Processing module 214 may process the received transaction information 106. Processing may include rendering the transaction information 106 into a hierarchical data structure 202. It should be understood that processing module 214 may translate the received transaction information 106 as discussed above.

According to various implementations of the invention, an output module 216 may use hierarchical data structure 202 to render uniform hierarchical information 112. Uniform hierarchical information 112 may uniformly refer to data that is otherwise referred to differently among transaction information 106 from the plurality of transactions 102.

According to various implementations of the invention, processing transaction information 106 may include using various combinations of data depending upon the transaction information 106 being processed. Furthermore, standard vocabularies may be used to define, describe, or otherwise refer to various data in transaction information 106. As such, processing module 214 may be associated with a configuration module 220.

According to various implementations of the invention, configuration module 220 may comprise a role manager 222, an entity manager 224, a role-entity manager 226, a location manager 228, and/or other suitable modules. Configuration module 220 may use these or other modules to describe data configurations, define standard vocabularies, or otherwise assist processing module 214 to represent data from transaction information 106 into hierarchical data structure 202. Data configurations may include permissible data types, permissible data combinations, and/or other data configurations. As such, configuration module 220 may assist processing module 214 to render data from transaction information 106 into hierarchical data structure 202.

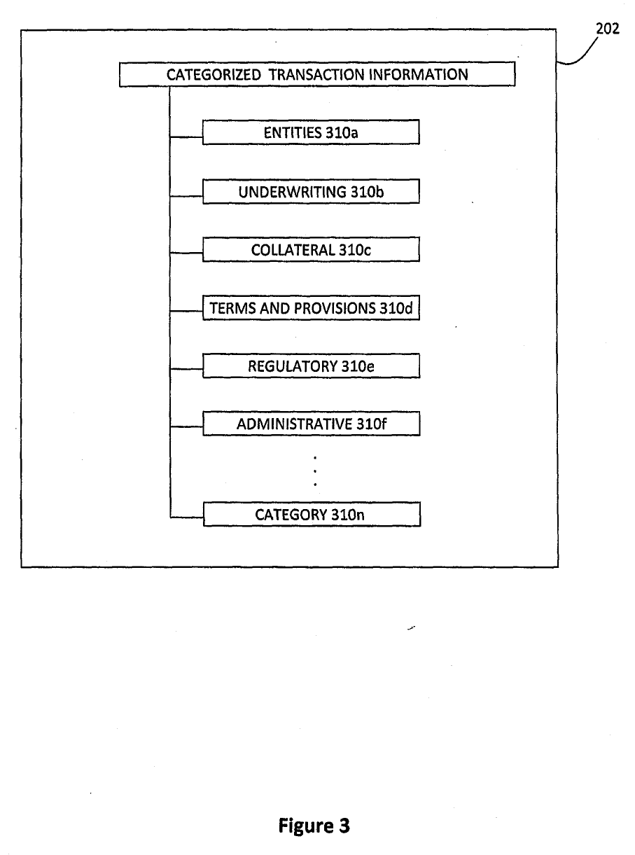

According to various implementations of the invention, as illustrated in FIG. 3, for example, hierarchical data structure 202 may categorize transaction information 106 into one or more categories such as, for example, categories 310a, 310b, 310c, 310d, 310e, 310f, and/or any other categories 310n. Categories 310 may define a top level of the hierarchical data structure 202. Categories 310 may include, for example, an Entities category 310a, an Underwriting category 310b, a Collateral category 310c, a Terms and Provisions category 310d, a Regulatory category 310e, an Administrative category 310f, and/or other categories 310n. For example, the Entities category 310a may describe parties related to a transaction. The Underwriting category 310b may describe criteria affecting the transaction, such as criteria affecting a decision to extend credit and/or other criteria. The Collateral category 310c may describe collateral that is related to the transaction. The Terms and Provisions category 310d may describe terms and provisions related to the transaction. The Regulatory category 310e may describe information related to the regulatory environment of the transaction. The regulatory environment may include, for example, federal, state, and/or local disclosure requirements. The Administrative category 310f may describe administrative rules related to the transaction. By categorizing transaction information 104 in this manner, a robust set of information related to transactions 102 may be represented in hierarchical data structure 202. For example, categories 310 may follow the natural manner in which professionals understand and organize transaction data. As such, emphasis is placed on data itself rather than the documents that accommodate that data.

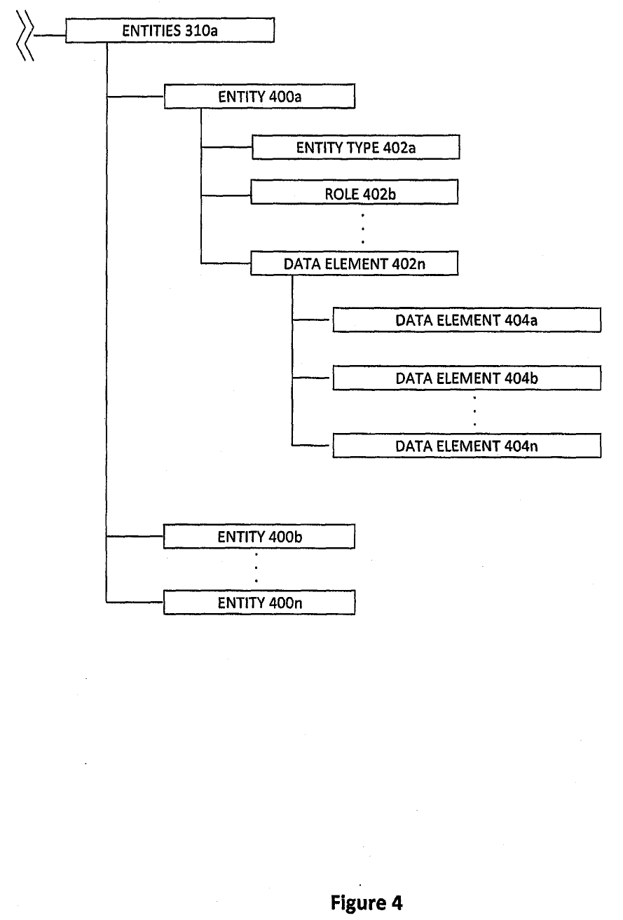

According to various implementations of the invention, as illustrated in FIG. 4, the hierarchical data structure 202 may include one or more data elements or data fields (discussed below). This structure reflects the plural-to-singular structure of hierarchical data structure 202. The data elements may describe data related to transactions 102 that may be categorized under a particular category. According to various implementations of the invention, each category may include one or more data elements. By having the ability to include more than one data element, each category 310 may include many types of similar data related to one another, enabling a robust representation of transaction information 106.

For example, according to various implementations of the invention, as illustrated in FIG. 4, Entities 310a may comprise one or more data elements 400a, 400b . . . 400n (data elements 400). Data elements 400 may describe data from transaction information 106 that may be categorized under the Entities 310a category, for example. Furthermore, each data element 400 may include other data elements 402a, 402b . . . 402n (data elements 402) that are nested within data element 400. Data elements 402, for example, may further describe data regarding data element 400. Still further, each data element 402, for example, may include one or more nested data elements 404a, 404b . . . 404n (“nested data elements 404”) that are nested within data element 402. Nesting of data elements may continue into further levels of nesting as would be apparent.

In particular, as illustrated, data element 400a may represent an entity (shown here as entity 400a). Entity 400a may describe a party related to the one or more transactions 102. A party may include, for example, a mortgage applicant, a loan officer, a government official, or any other party related to the one or more transactions 102. There may be many parties to a transaction 102. As such, entities 310a may include multiple data elements 400 representing each of the parties to the transaction 102. According to various implementations of the invention, each party among the parties may be uniquely identified and represented by a data element 400. Entities may be identified by name, numeric identifier, or any other identifier so long as the identifier is unique among the set of identifiers that each identify an entity. Furthermore, the entity identifier may be represented within the hierarchical data structure 202 (not otherwise illustrated).

Each party related to a transaction 106 may correspond to one or more different types of parties. For example, an “Individual” is a different type of party than a “Business” or “Corporation.” As such, according to various implementations of the invention, entity 400a, for example, may include a nested data element Entity Type 402a. An Entity Type 402a describes a type of entity such as, for example, “Individual,” “Corporation,” or other type of entity. Entity Type 402a may be predefined using a standard, normalized, vocabulary, such as the exemplary vocabulary listed in Table 1 herein. For example, a mortgage applicant may be defined as an “Individual” entity type while a business entity may be defined as a “Corporation” entity type.

According to various implementations of the invention, entity 400a may have different data requirements based on entity type 402a. In other words, an “Individual” may have information associated with the Individual that is different from information associated with a “Business.” For example, the Individual may be associated with information related to a spouse while the Business would not. Furthermore, entity 400a may have similar data that refers to different information. For example, an “address” of the Individual may refer to the home mailing address of the Individual. By contrast, for example, the “address” of the Business may be a place of incorporation. This reflects various different data combinations that may be represented by the hierarchical data structure 202. In particular, entity type 402a may drive or define other data elements within hierarchical data structure 202. Furthermore, a particular role (discussed below) may require a particular entity type 402a definition. Exemplary roles and their required entity types are listed in Table 1 below.

TABLE 1
Exemplary roles and entity types.

| Role | Entity Type |
|---|---|
| ResolvingParty | Sole Proprietorship |
| | General Partnership |
| | Limited Partnership |
| | Limited Liability Partnership |
| | Limited Liability Company |
| | Corporation or Professional Corporation |
| | Business Trust |
| | Association or Organization |
| | Governmental Entity |
| SigningBusinessEntity BorrowerAuthorizedSigner | Sole Proprietorship |
| GuarantorAuthorizedSigner | General Partnership |
| HypothecatorAuthorizedSigner NoticeOfLimitation | Limited Partnership |
| | Limited Liability Partnership |
| | Limited Liability Company |
| | Corporation |
| | Trust with Individual Trustee |
| | Trust with Non-Individual Trustee |
| Contractor | Individual |
| ContractOtherParty | Sole Proprietorship |
| ReportingAgency | General Partnership |
| Landlord | Limited Partnership |
| FarmProductPotentialBuyer NoticeOfLimitationExecutingParty | Limited Liability Partnership |
| Mortgagor | Limited Liability Company |
| AttorneyInFact | Corporation |
| AccountOwner | Trust |
| Borrower | Association |
| Guarantor | Governmental Entity |
| Hypothecator | |
| LifeInsuranceBeneficiary | |
| Architect | |
| ElectronicDisclosureAuthorizedSigner FiduciaryAppointee | Individual |
| | Non-Individual |
| Trustee | Corporation |
| | Partnership |
| | Limited Liability Company |
| | Sole Proprietorship |
| | Limited Liability Partnership |
| | Association (Trust Authorization Use Only) |
| | Governmental Entity (Trust Authorization Use Only) |
| MortgageBroker | Sole Proprietorship |
| | General Partnership |
| | Limited Partnership |
| | Limited Liability Partnership |
| | Limited Liability Company |
| | Corporation |
| LifeInsuranceTrusteeBeneficiary LandlordTrustee | Individual |
| | Non-Individual |
| RealEstateNotary | One Notary for All Signers |
| | One Notary For Each Signer |
| RealEstateSubordinator Subordinator | Individual |
| | non-individual |

According to various implementations of the invention, entity manager 224 may define, describe, validate, or otherwise permit processing of entity types 400a and the various data combinations resulting from different entity types 400a. Processing module 214 may associate with entity manager 224 in order to manage an entity type 402a of entity 400a.

Each party related to a transaction 106 may play different roles. For example, an entity 400a applying for a loan may play a “Borrower” role while an entity 400a that approves a loan may play a “LendingInstitution” role. Other roles are contemplated. As such, according to various implementations of the invention, entity 400a, for example, may include a nested data element illustrated as role 402b. Role 402b may be predefined using a standard, normalized, vocabulary, such as the exemplary vocabulary listed in Table 2 herein.

TABLE 2
Exemplary Entity Roles

| | |
|---|---|
| AccountChangeRequestingParty | AccountOwner |
| AccountOwnerAuthorizedSigner | AccountOwnerBeneficiary |
| AccountOwnerCustomerContact | AccountOwnerEmployer |
| AffiliatedBusinessArrangementEntity | AlternateCreditor |
| ApplicantOnStatementOfCreditDenial | Appraiser |
| Architect | ArchitectAcknowledgeeBusiness |
| ArchitectAcknowledgeeIndividual | ArchitectAttestingParty |
| ArchitectAuthorizedSigner | ArchitectOwner |
| AssignmentOfLeasesAndRentsRecordingAgency | ATMApplicant |
| ATMApplicantEmployer | AttestingParty |
| AttorneyInFact | AttorneyInFactAttestingParty |
| AttorneyInFactAttestingParty2 | AttorneyInFactAuthorizedSigner |
| AttorneyInFactSpouse | AttorneyInFactSuccessor |
| AuthorizedSigner | AuthorizedSignerBorrower |
| Beneficiary | BeneficiaryDeceased |
| BeneficiaryRepresentative | BondBeneficiary |
| BondBeneficiaryCoOwner | BondCoOwner |
| BondPurchaser | BondRecipient |
| Borrower | BorrowerAuthorizedSigner |
| BorrowerCertificationSigner | BorrowerExecutiveOfficer |
| BorrowerMilitary | BorrowerSpouse |
| BorrowerTrusteeCertificationSigner | BroadResolutionSigner |
| Build | Builder |
| BusinessAcknowledgees | CashDepositHolder |
| CertifyingPartyAuthorizedSigner | CertifyingTINAttestor |
| ClaimingBeneficiary | ClaimingBeneficiaryAuthorizedSigner |
| CollateralCoOwner | CollateralCoOwnerCertificationSigner |
| CollateralCoOwnerSpouse | CollateralInsurer |
| CollateralOwner | CollateralOwnerIndividualAcknowledgee |
| CommercialAuthorizedSigner | CommercialLoanIndividual |
| ConsentingElectronicSigner | ConsolidationExtensionModificationMortgagor |
| ConsumerRealEstateSecurityInstrumentMortgagor | ConsumerReportingAgency |
| Contractor | ContractorAttestingParty |
| ContractorAuthorizedSigner | ContractorBusinessAcknowledgee |
| ContractorIndividualAcknowledgee | ContractorOwner |
| ContractOtherParty | Cosigner |
| CosignerSpouse | CreditDisabilityInsurance |
| CreditDiscountApplicant | CreditInsuranceRequestSigner |
| CreditLifeInsurance | CreditLifeInsuranceDebtProtection |
| Creditor | CurrentServicer |
| Custodian | DairyProductPurchaser |
| DairyProductPurchaserAuthorizedSigner | DairyProductPurchaserWitness |
| DairyProductPurchaserWitness2 | DeedOfTrustTrustee |
| Depositor | DepositServicingDocumentSigner |
| DepositTrustee | DocumentPreparer |
| EFTPostingMerchant | ElectronicDisclosureAuthorizedSigner |
| ElectronicDisclosureCustomer | ElectronicSignatureConsentingParty |
| ElectronicSignatureConsentingPartySigner | Employer |
| ESADepositor | ESADesignatedBeneficiary |
| ESAResponsibleIndividual | ESAResponsibleIndividualEmployer |
| EscrowHolder | ExistingMortgagee |
| ExpectedEncumbranceBeneficiary | FacsimileSigner |
| FarmProductPotentialBuyer | FarmProductPotentialBuyerContact |
| FederalAgency | FederalPaymentReceivingParty |
| FHALender | FiduciaryAppointee |
| FiduciaryWard | FinancialInstitution |
| FinancialInstitutionAdverseActionContact | FinancialInstitutionATMContact |
| FinancialInstitutionATMDispute | FinancialInstitutionATMDisputeContact |
| FinancialInstitutionATMSafetyContact | FinancialInstitutionATMSecurity |
| FinancialInstitutionAuthorizedBackupWitholdingRepresentative | FinancialInstitutionAuthorizedSigner |
| FinancialInstitutionAuthorizedSigner2 | FinancialInstitutionBiennialRenewalSigner |
| FinancialInstitutionBranch | FinancialInstitutionCDCounterSigner |
| FinancialInstitutionConstructionLoanOriginator | FinancialInstitutionContact |
| FinancialInstitutionCreditDenialSender | FinancialInstitutionDistributing |
| FinancialInstitutionEFTInvestigationContact | FinancialInstitutionEFTOriginator |
| FinancialInstitutionEFTRepresentative | FinancialInstitutionEFTTransactionBalancingBranch |
| FinancialInstitutionElectronicDisclosureContact | FinancialInstitutionHELOC |
| FinancialInstitutionIntermediary | FinancialInstitutionIssuing |
| FinancialInstitutionLending | FinancialInstitutionLendingDecisionOfficer |
| FinancialInstitutionMortgageDisclosureProvider | FinancialInstitutionOriginatorOrReceiving |
| FinancialInstitutionParticipationPurchasing | FinancialInstitutionParticipationPurchasingSigner |
| FinancialInstitutionPreauthorizedPayment | FinancialInstitutionPreparer |
| FinancialInstitutionPriorTransaction | FinancialInstitutionPurchasing |
| FinancialInstitutionReceiving | FinancialInstitutionRepresentativeApprovingBackupWithHolding |
| FinancialInstitutionRepresentativeATMApplication | FinancialInstitutionServicingTransfer |
| FinancialInstitutionStopPaymentReceiving | FinancialInstitutionSubstituteCheck |
| FinancialInstitutionTransactionBranch | FinancialInstitutionTransactionInstitution |
| FinancialInstitutionTransferServicingContact | FinancialInstitutionVerifyingRepersentative |
| FirstLienPrivateInvestor | FundingInstitution |
| FundsTransferBeneficiary | FundsTransferConfirmer |
| FundsTransferParty | FundsTransferVerifierSigner |
| GapInsuranceSigner | GuaranteeIndividualAcknowledgee |
| Guarantor | GuarantorAttestingParty |
| GuarantorAttorneyInfact | GuarantorAuthorizedSigner |
| GuarantorBusinessAcknowledgee | GuarantorCertificationSigner |
| GuarantorIndividualAcknowledgee | GuarantorSpouse |
| GuarantorTrusteeAuthorizedSigner | GuarantorTrusteeCertificationSigner |
| GuardianDelegate | HazardInsuranceParty |
| HELOCThirdPartyFeePaidParty | HomeEquityConversionMortgageCounselingAgency |
| HSAAccountAuthorizedSigner | HSAAccountOwner |
| HUDSecretary | HUDVeteranAffairsSponsor |
| Hypothecator | HypothecatorAttestingParty |
| HypothecatorAuthorizedSigner | HypothecatorBusinessAcknowledgee |
| HypothecatorCertificationSigner | HypothecatorIndividualAcknowledgee |
| HypothecatorSpouse | HypothecatorTrusteeAuthorizedSigner |
| HypothecatorTrusteeCertificationSigner | IndependantCertifier |
| IndirectLendingDealer | IndirectLendingDealerAuthorizedSigner |
| IndividualAcknowledgee | IndividualGuarantor |
| IndividualHypothecator | IndividualSubordinator |
| InstallmentContractAssignee | InsuranceAgent |
| InsuranceAgentAntiCoercion | InsuranceAnnuityCompany |
| InsuranceBeneficiaryAttestingParty | InsuranceBeneficiaryAuthorizedSigner |
| InsuranceBeneficiaryBusinessAcknowledgee | InsuranceBeneficiaryIndividualAcknowledgee |
| InsuranceCompany | InsurancePolicyBeneficiary |
| InsurorAnnuityGrantor | InterestedParty |
| Interviewer | IRSRequestor |
| IRSTaxpayer | IRSTaxpayerSigner |
| IRSTaxpayerSpouse | IRSThirdParty |
| JuniorLienHolder | JuniorLienHolderAuthorizedSigner |
| JuniorLienHolderSignerAcknowledgee | LandContractPurchaser |
| LandContractSeller | Landlord |
| LandlordAttestingParty | LandlordAuthorizedSigner |
| LandlordBusinessAcknowledgee | LandlordIndividualAcknowledgee |
| LandlordSpouse | LandlordTrustee |
| LandTrustTrustee | LandTrustTrusteeSigner |
| LenderAcknowledgee | LenderOfficer |
| LenderToBePaidOff | LendingFinancialInstitutionAuthorizedSigner |
| LetterOfCreditAdvisingBank | LetterOfCreditApplication |
| LetterOfCreditBeneficiary | LetterOfCreditCargoCompany |
| LetterOfCreditConfirmingBank | LetterOfCreditEdibleGoodsCertifyingParty |
| LetterOfCreditHealthSanitationCertifyingParty | LetterOfCreditMultimodalTransportDocumentIssuer |
| LetterOfCreditOriginator | LetterOfCreditQualityCertifyingEntity |
| LetterOfCreditReceiver | LetterOfCreditWeightOrGoodsCertifyingEntity |
| LienNoticeDesignatedRecipient | LifeInsuranceAgent |
| LifeInsuranceBeneficiary | LifeInsuranceBeneficiaryAttestor |
| LifeInsuranceCompany | LifeInsuranceCompanyRepresentative |
| LifeInsuranceInsuredParty | LifeInsuranceSoleProprietorBeneficiary |
| LifeInsuranceTrusteeBeneficiary | LoanAgreementGuarantor |
| LoanDisbursementReceipient | LoanDisbursementRecipient |
| LoanOfficer | LoanQuotePreparer |
| LoanServicer | LockingGuaranteeLender |
| ManufacturedHomeMaker | MoneyServicesBusiness |
| MortgageAssignee | MortgageBroker |
| MortgageBrokerAffiliatedCompany | MortgageBrokerLoanOfficer |
| MortgageBrokerParentCompany | MortgageBrokerPrimaryLender |
| MortgageBrokerPrimaryLender2 | MortgageBrokerPrimaryLender3 |
| MortgageBrokerRepresentative | Mortgagee |
| MortgageInsuranceParty | MortgageLender |
| MortgageLoanOriginationBroker | MortgageNotary |
| Mortgagor | MortgagorNonOwnerSpouse |
| MortgagorSpouse | MortgagorSpouse2 |
| NavajoDebtCounsleor | NavajoOtherEntityIndividual |
| NewServicer | NightBagAgent |
| NonAccountOwnerSpouse | NonBorrowerSpouse |
| NonOwnerSpouseCertificationSigner | NonOwnerTaxFavoredAccountDistributionRequestor |
| NonPropertyOwnerTitleHolder | Notary |
| NoticeOfLimitation | NoticeOfLimitationAttestor |
| NoticeOfLimitationAuthorizedSigner | NoticeOfLimitationBusinessAcknowledgee |
| NoticeOfLimitationExecutingParty | NoticeOfLimitationIndividual |
| NoticeOfLimitationIndividualAcknowledgee | NoticeOfLimitationSoleProprietor |
| NoticeOfLimitationSpouse | NoticeOfLimitationTrustee |
| OriginalMortgagee | OriginationCertificateIssuingAgency |
| OtherCourier | OutsideInformationSource |
| PartnerAssignor | Partnership |
| PartyToRecieveDocumentsOnBehalfOfRealPropertyOwner | PowerOfAttorneyPrincipal |
| PowerOfAttorneySuccessor | PreAuthorizedPaymentOriginator |
| PresentLienHolder | PreviousEmployer |
| PrimaryVehicleCreditor | PrincipalWitness |
| PrincipalWitness2 | PublicTrustee |
| QualifiedWrittenRequestContact | QualityCertifier |
| QuestionsAgency | RealEstateAgent |
| RealEstateAssignee | RealEstateNotary |
| RealEstateSecurityAgreementAcknowledgee | RealEstateSecurityAgreementPurchaser |
| RealEstateSecurityInstrumentPurchaseParty | RealEstateSecurityInstrumentSignerAuthorizedSigner |
| RealEstateSubordinationAuthorizedSigner | RealEstateSubordinator |
| RealPropertyWitness | RealPropertyWitness2 |
| ReceivingParty | RecordableInstrumentPreparer |
| RecordableInstrumentReturnToParty | RecordingAgency |
| RemainingEncumbranceBeneficiary | RemainingLienHolder |
| RemovedAuthorizedSigner | RemovedSafeDepositDeputy |
| RemovedTrustee | RemovedUTMASuccessorCustodian |
| ReportingAgency | RepresentativeFeePayableTo |
| ResolutionAttestingParty | ResolvedBusiness |
| ResolvingParty | ResolvingPartyAttestor |
| ResolvingPartyAuthorizedSigner | ResolvingPartyRepresentative |
| SafeDepositBoxDeputy | SafeDepositBoxLegalRepresentative |
| SafeDepositBoxRenter | SafeDepositBoxRenterAppointingALegalRepresentative |
| SafeKeepingRepresentative | SecurityInstrumentAssignee |
| Seller | SellerAssistedLoanProvider |
| SellerRepresentative | SellingAgent |
| SeniorLienHolder | ServiceContractCompany |
| SettlementAgent | SettlementProvider |
| SigningBusinessEntity | SoleProprietorAccountOwner |
| SoleProprietorArchitect | SoleProprietorAttorneyInFact |
| SoleProprietorBorrower | SoleProprietorContractor |
| SoleProprietorContractOtherParty | SoleProprietorFarmProductPotentialBuyer |
| SoleProprietorGuarantor | SoleProprietorHypothecator |
| SoleProprietorLandlord | SoleProprietorResolvingParty |
| StateRegulatingAgency | StockIssuer |
| StopPaymentOrderSigner | SubObligor |
| Subordinator | SubordinatorSigner |
| SubordinatorWitness | SubordinatorWitness2 |
| TaxFavoredAccountAuthorizedSigner | TaxFavoredAccountBeneficiary |
| TaxFavoredAccountNonAccountOwnerDistributionRequestor | TaxFavoredAccountOwner |
| TaxFavoredAccountWitness | TaxpayerSpouse |
| ThirdPartyFeePayee | ThirdPartyOriginator |
| TransferAgreementAuthorizedOriginator | Trust |
| TrustAccountOwner | TrustBeneficiary |
| TrustCreator | Trustee |
| TrusteeAttestor | TrusteeAttorneyInFact |
| TrusteeDeedOfTrustNoticeOfSaleOrDefault | TrusteeDischargeOfDeedOfTrust |
| TrusteeLandlord | TrusteeResolvingParty |
| TrustMortgagor | UCCRecordingAgency |
| Underwriter | UTMACustodian |
| UTMACustodianEmployer | UTMACustodianWitness |
| UTMADesignationWitness | UTMAMinor |
| UTMAMinorEmployer | UTMASuccessor |
| UTMATransferor | UTMATransferorWitness |
| VehicleBroker | VehicleContractOtherPayableParty |
| VehicleDealer | VeteranAffairsAuthorizedAgent |
| Warrantor | WireTransferConfirmingParty |
| Witness | Witness2 |

According to various implementations of the invention, entity 400a may have different data requirements based on role 402b. In other words, a “Borrower” may have information associated with the Borrower that is different from information associated with a “LendingInstitution.” For example, the Borrower may be associated with information related to personal income while the Business would not. This reflects various different data combinations that may be represented by the hierarchical data structure 202. In particular, role 402b may drive or define other data elements within hierarchical data structure 202.

According to various implementations of the invention, a data element 400 may be used to reduce the redundancy of transaction information 106 for a transaction 102. The result is a many-fold reduction in the number of data points that is mapped to by users of the hierarchical data structure 202 and a concomitant reduction in the number of data that is to be entered by a party when processing and/or executing a transaction. For example, data entered by a financial institution may be minimized when processing a transaction such as originating a new loan, opening a new account, and/or other transaction.

According to various implementations of the invention, role 402b may be used, inter alia, to reduce the number of data points that is mapped to by users of the hierarchical data structure. A transaction may require certain data related to the parties to the transaction to be captured and processed. Such data often includes, for example, an identity of a party, street address, city address, state address, zip code, various phone numbers, and/or other data. Furthermore, each party may serve various roles in the transaction. For example, a party may be the applicant, who is also the borrower, who, in turn, is also the mortgagor. According to various implementations of the invention, instead of redundantly storing/capturing information related to the applicant, borrower, and mortgagor, this information is captured once by using roles. The role data element 402b, for example, may reduce the transaction information associated with the entity data element 400a. In this example, the applicant, borrower, and mortgagor are assigned an entity ID. The role data element 402b is not limited to the entity data element 400a. Various collateral (not otherwise shown), for example, may serve one or more roles within a credit transaction. Other data elements may similarly be used to streamline the hierarchical data structure.

According to various implementations of the invention, role manager 222 may define, describe, or otherwise permit processing of roles 402b and the various data combinations resulting from different roles 402b. Processing module 214 may associate with role manager 222 in order to manage an roles 402b of entity 400a.

According to various implementations of the invention, certain combinations of entity types 402a and roles 402b may be restricted. For example, an entity 400a described by entity type 402a of “Individual” may not be described by a role 402b of “FinancialInstitutionBranch” because an individual would not be described as having this role 402b. Furthermore, according to various implementations of the invention, certain combinations of entity types 402a and roles 402b may be permissibly allowed. Alternatively or additionally, certain combinations of entity types 402a and roles 402b may be mandatory when certain entity types 402a and roles 402b are used.

According to various implementations of the invention, Role-Entity manager 226 may define, describe, validate, or otherwise permit processing of these and other combinations of entity types 402a and roles 402b. Processor module 314 may associate with Role-entity manager 226 in order to define various restricted, permissibly allowed, mandatory, or other combinations of entity types 402a and roles 402b.

As described above, entity type 402a and/or role 402b may further drive, for example, other data elements. For example, a location use code 402c may be affected by entity type 402a and/or role 402b. Location use code 402c may be a data element that is nested within entity 400a, for example. Location use code 402c may be used to describe location information of an entity. Location information may describe geographic, electronic (such as website, email, etc.), or other location information of an entity 400a. Location use code 402c may describe the type or purpose of location information that is described. For example, location use code 402c “Account” may describe an address of a deposit account while location use code 402c “Birth” may describe a country of birth for an entity 400a. In this manner, location use code 402c may be used to represent a variety of information related to locations.

According to various implementations of the invention, location use code 402c may be based or depend upon other data elements such as entity type 402a, role 402b, or any other data element. For example, a location use code 402c of “Primary” may be different depending upon the entity type 402a of an entity 400a. In particular, location use code 402c of “Primary” for an entity 400a of entity type 402b “Individual” may indicate location information that relates to a primary mailing address for the Individual. By contrast, location use code 402c of “Primary” for an entity 400a of entity type 402b “Business” may indicate location information that relates to a place of business for the Business. Use of location use code may vary depending on the entity associated with the location use code.

Furthermore, depending on role 402b, certain location use codes 402c may be used. For example, location use code 402c “PreviousEmployer” may be used for entity role 402b of “Borrower.” Other types of location use code 402c are contemplated. For example, location use code 402c may be predefined using a standard, normalized, vocabulary, such as the exemplary vocabulary listed in Table 3 herein.

TABLE 3
Exemplary Location Use Codes and Brief Descriptions.

| | |
|---|---|
| Account | Address of the Deposit Account, if different from that of the |
| | account holder. |
| AlternateAccount | Address of the Account, if different from that of the account |
| | owner. |
| Birth | Country of the depositor's or signer's birth. |
| BondMailing | Address where bonds are to be mailed. |
| Branch | Branch Office location of the Originator's Financial Institution. |
| BusinessRegistered | Address at which the Role is organized, formed or registered; or |
| | where the governmental entity is based. |
| Destination | Address where the goods are being shipped to under the Letter |
| | of Credit. |
| ExistingHUDRealEstate | Address where the Borrower's real estate is located, on which |
| | there is a HUD/FHA-insured mortgage. |
| Filing | State in which the trust was created or state in which the |
| | Account Holder has filed its organizational establishment |
| | request. |
| Litigation | County where the litigation process takes place. |
| Mailing | Mailing address of the entity Role, if different from permanent |
| | residence. |
| NotaryVenue | Address at which the notarization is being sworn. |
| Origin | Address where the goods being shipped to a buyer are |
| | manufactured or from which they originate. |
| PowerOfAttorneyGrantingVenue | Address where the power of attorney was granted or created. |
| Previous | Address of the taxpayer, as shown on the taxpayer's last tax |
| | return filed, if different from the current address. |
| PreviousEmployer | Address of the Borrower's previous employer. |
| PreviousEmployer and (Country!=) | Address of the Borrower's previous employer, if outside of USA, |
| | Canada, or Mexico. |
| PreviousEmployer and (Country = Mexico) | State or zone in Mexico where the Borrower's previous |
| | employer is located. |
| PreviousResidence | Borrower's most recent previous address. |
| Primary | Primary address of the entity Role. |
| Registered | State in which the non-individual Party executing the Notice of |
| | Limitation is organized, formed, or registered. |
| Residence | State in which the entity Role is a resident. |
| Venue | Address at which the acknowledgment will be performed. |

Location use code manager 228 may validate, manage, or otherwise deal with these and other combinations for location use code 402c, as well as various types of location use codes 402c. According to various implementations of the invention, processing module 214 may associate with location use code manager 228 in order to process these and other inter-relationships.

Using the hierarchy of transaction information may allow for a robust representation of the plurality of transactions 102 and disparate data that may be associated therewith.

The following exemplary portions of hierarchical data structure 202 are illustrated below using XML code merely for convenience without being limiting.

Multiple entities: Individual Borrower, Non-Borrowing Spouse, Loan Officer Example

```
<Entities>
    <Entity id=“Borrower1”>
        <Roles>
            <Role>Borrower</Role>
        </Roles>
        <Individual>
            <MaritalStatus>1</MaritalStatus> <!-- Married -->
            <Date>
                <Birth>12/31/1901</Birth>
            </Date>
        </Individual>
        <EntityType>1</EntityType> <!-- Individual -->
        <Name>
            <Salutation>
                <Type>1</Type> <!-- Mr. -->
            </Salutation>
            <First>John</First>
            <Middle>Q.</Middle>
            <Last>Adams</Last>
            <Suffix>III</Suffix>
        </Name>
        <Phone>
            <Home>616-555-0123</Home>
            <Business>616-555-6789</Business>
            <BusinessExtension>246</BusinessExtension>
            <Fax>616-555-3456</Fax>
        </Phone>
        <Email>
            <Personal>jqadams@yahoo.com</Personal>
        </Email>
        <Locations>
            <Location Use=“Primary”>
                <PrimaryAddressLine>123
                Main St.</PrimaryAddressLine>
                <City>Scranton</City>
                <StateOrProvince>PA</StateOrProvince>
                <PostalCode>44444</PostalCode>
            </Location>
        </Locations>
        <TIN>
            <SSN>
                <FullNumber>111-22-3333</FullNumber>
            </SSN>
        </TIN>
    </Entity>
    <Entity id=“JaneAdams”>
        <Roles>
            <Role>NonBorrowerSpouse</Role>
        </Roles>
        <Name>
            <First>Jane</First>
            <Middle>E.</Middle>
            <Last>Adams</Last>
        </Name>
        <TIN>
            <SSN>
                <FullNumber>123-45-6789</FullNumber>
            </SSN>
        </TIN>
    </Entity>
    <Entity id=“loanofficer”>
        <Name>
            <First>John</First>
            <Middle>Q.</Middle>
            <Last>Smith</Last>
        </Name>
        <Roles>
            <Role>LoanOfficer</Role>
        </Roles>
        <Business>
            <Number>
                <License>1234</License>
            </Number>
        </Business>
        <Signer>
            <DigitalSignatureImage><![CDATA[<file
    type=“image”>\\Server1\DigSigs\JohnSmithSig.bmp</file>]]
    </DigitalSignatureImage> </Signer>
        <Phone>
            <Business>212-555-1234</Business>
        </Phone>
        <Locations>
            <Location Use=“Primary”>
                <PrimaryAddressLine>1001
                Bank St.</PrimaryAddressLine>
                    <SecondaryAddressLine>Suite
    706</SecondaryAddressLine>
        <City>Chicago</City>
                <ProvinceOrState>IL</ProvinceOrState>
                <PostalCode>54321</PostalCode>
            </Location>
        </Locations>
    </Entity>
</Entities>
```

IRA Transaction Example

```
<Entities>
    <Entity id=“JohnDoe”>
        <Roles>
            <Role>AccountOwner</Role>
        </Roles>
        <EntityType>1</EntityType> <!-- Individual -->
        <Name>
            <First>John</First>
            <Last>Doe</Last>
        </Name>
        <Locations>
            <Location Use=“Residence”>
                <PrimaryAddressLine>101 Happy Valley
Dr.</PrimaryAddressLine>
                <City>Portland</City>
                <StateOrProvince>ME</StateOrProvince>
                <PostalCode>10101</PostalCode>
            </Location>
        </Locations>
        <TIN>
            <SSN>
                <FullNumber>987-65-4321</FullNumber>
            </SSN>
        </TIN>
    </Entity>
    <Entity id=“JaneDoe”>
        <Roles>
            <Role>Beneficiary</Role>
        </Roles>
            <Name>
                <First>Jane</First>
                <Last>Doe</Last>
            </Name>
        <TIN>
            <SSN>
                <FullNumber>123-45-6789</FullNumber>
            </SSN>
        </TIN>
    </Entity>
</Entities>
```

Corporate Borrower with Hypothecation Example

```
<Entities>
    <Entity id=“AbcInc”>
        <Roles>
            <Role>Borrower</Role>
        </Roles>
        <Name>
            <Business>ABC Inc.</Business>
        </Name>
        <EntityType>7</EntityType> <!-- Corporation -->
        <Business>
            <Resolution>
                <Date>
                    <Document>1/1/2007</Document>
                </Date>
            </Resolution>
        </Business>
        <Locations>
            <Location Use=“Primary”>
                <PrimaryAddressLine>123  Industrial
Ave.</PrimaryAddressLine>
                <City>Toledo</City>
                <StateOrProvince>OH</StateOrProvince>
                <PostalCode>55555</PostalCode>
            </Location>
        </Locations>
        <TIN>
            <TaxIDNumber>11-2222222</TaxIDNumber>
        </TIN>
        <SigningEntities>
            <SigningEntity>JohnDoe</SigningEntity>
            <SigningEntity>RichardRoe</SigningEntity>
        </SigningEntities>
    </Entity>
    <Entity id=“JohnDoe”>
        <Roles>
            <Role>AuthorizedSigner</Role>
            <Role>Hypothecator</Role>
        </Roles>
        <Name>
            <First>John</First>
            <Last>Doe</Last>
        </Name>
        <Individual>
            <Title>
                <Job>President</Job>
            </Title>
        </Individual>
        <Phone>
            <Business>616-555-6789</Business>
            <BusinessExtension>101</BusinessExtension>
            <Fax>616-555-3456</Fax>
        </Phone>
        <Email>
            <Business>jdoe@abc.com</Business>
        </Email>
        <Signer>
            <DigitalSignatureImage><![CDATA[<file
type=“image”>\\Server1\DigSigs\JohnDoeSig.bmp</file>]]
</DigitalSignatureImage>
            </Signer>
    </Entity>
    <Entity id=“RichardRoe”>
        <Roles>
            <Role>AuthorizedSigner</Role>
        </Roles>
        <Name>
            <First>Richard</First>
            <Last>Roe</Last>
        </Name>
        <Individual>
            <Title>
                <Job>Vice-President</Job>
            </Title>
        </Individual>
        <Phone>
            <Business>616-555-6788</Business>
            <BusinessExtension>102</BusinessExtension>
            <Fax>616-555-3456</Fax>
        </Phone>
        <Email>
            <Business>rroe@abc.com</Business>
        </Email>
        <Signer>
            <DigitalSignatureImage><![CDATA[<file
type=“image”>\\Server1\DigSigs\RichardRoeSig.bmp</file>]]
</DigitalSignatureImage>
        </Signer>
    </Entity>
</Entities>
```

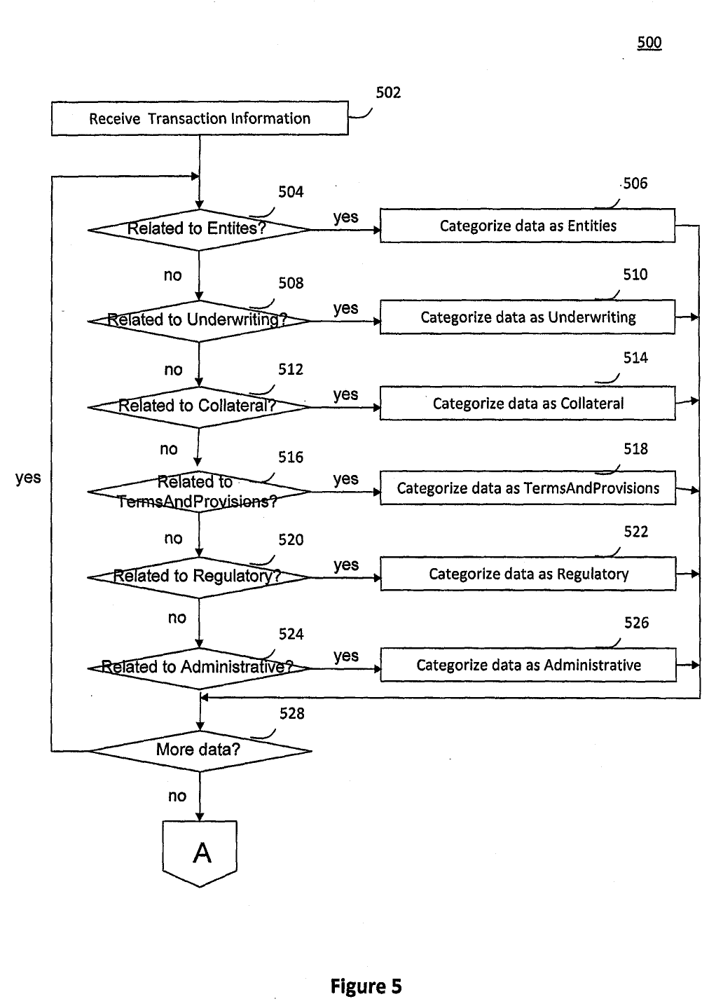

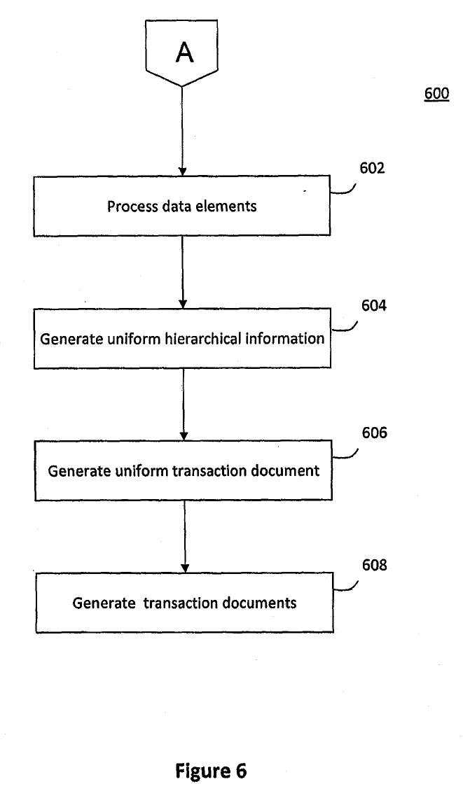

According to various implementations of the invention, FIG. 5 illustrates a flow diagram of an exemplary process 500 for categorizing transaction information 106. Process 500 may begin in an operation 502, where transaction information 106 is received. Different transactions may use different terms in the transaction information 106. As such, the received transaction information may have been translated into a standard format. Alternatively or additionally, the received transaction information may be translated after receipt. At any rate, once transaction information 106 is received, processing may proceed to an operation 504, wherein whether the data is related to entities 310a is determined. If in operation 504, the data is related to entities 310a, then processing may proceed to an operation 506, wherein the data is categorized as entities 310a. Processing may then proceed to an operation 528, wherein if more data is present, processing may return to an operation 504 for the additional data. If in operation 528, no more data is present, processing may proceed to “A,” as discussed with respect to FIG. 6, for example.

Returning to operation 504, if data is not related to entities 310a, processing may proceed to an operation 508, wherein whether the data is related to underwriting 310b is determined. If in operation 508, the data is related to underwriting 310b, then processing may proceed to an operation 510, wherein the data is categorized as underwriting 310b. Processing may then proceed to an operation 528 as before.

Returning to operation 504, if data is not related to underwriting 310b, processing may proceed to an operation 512, wherein whether the data is related to collateral 310c is determined. If in operation 512, the data is related to collateral 310c, then processing may proceed to an operation 514, wherein the data is categorized as collateral 310c. Processing may then proceed to an operation 528 as before.

Returning to operation 504, if data is not related to collateral 310c, processing may proceed to an operation 516, wherein whether the data is related to TermsAndProvisions 310d is determined. If in operation 516, the data is related to TermsAndProvisions 310d, then processing may proceed to an operation 518, wherein the data is categorized as TermsAndProvisions 310d. Processing may then proceed to an operation 528 as before.

Returning to operation 504, if data is not related to TermsAndProvisions 310d, processing may proceed to an operation 520, wherein whether the data is related to regulatory 310e is determined. If in operation 516, the data is related to regulatory 310e, then processing may proceed to an operation 522, wherein the data is categorized as regulatory 310e. Processing may then proceed to an operation 528 as before.

Returning to operation 504, if data is not related to regulatory 310e, processing may proceed to an operation 524, wherein whether the data is related to administrative 310f is determined. If in operation 524, the data is related to administrative 310f, then processing may proceed to an operation 526, wherein the data is categorized as administrative 310f. Processing may then proceed to an operation 528 as before.

According to various implementations of the invention, FIG. 6 illustrates a flow diagram of an exemplary process 600 for representing transaction information 106 that has been categorized according to various implementations of the invention. Each category may comprise one or more data elements. For example, the Entities category may include an entity data element that describes a party to a transaction being processed. The entity data element may itself comprise one or more nested data elements.

Process 600 may begin in an operation 602, wherein various data elements 400a-n, 402a-n, and 404a-n, among others, are processed and rendered into hierarchical data structure 202. For example, the one or more nested data elements may comprise a role data element. The role data element may describe the role played by the entity in the transaction. For example, a mortgage applicant may have a role of “Borrower.” Furthermore, the one or more second data elements may comprise an Entity Type data element. The Entity Type data element may describe the type of entity for an entity in the transaction. For example the mortgage applicant may have an Entity Type of “Individual,” indicating that the mortgage applicant is an Individual as opposed to a “Corporation” Entity Type. The one or more nested data elements may comprise location information. Location information may be described by a Location Use Code that relates the location information to the entity. For example, a Location Use Code of “Primary” may relate that the location information is the primary address of the mortgage applicant. Location Use Codes may depend on the roles of the entity and other parameters of the transaction. By focusing on the data from the transaction information itself and the relationships therein, operation 602 may provide a robust set of information that may be stored in a single format and reused, thereby efficiently tracking data from plurality of transactions and types of transactions.

In an operation 604, uniform hierarchical information 112 may be generated based on hierarchical data structure 202. In an operation 606, uniform transaction document 114 may be generated based on the uniform hierarchical information 112. In an operation 608, transaction documents 116 may be generated based on uniform transaction document 114. In this manner, uniform transaction document 114 may include some or all data necessary to process, complete, or otherwise provide information related to any relevant transactions 116. Returning to operation 604, if the received transaction information has not been translated, processing may proceed to an operation 608, wherein translation to a standard format may be performed. Processing may proceed to operation 606.

In operation 606, the received transaction information may be processed according to a hierarchical data structure 602. Data from the received transaction information may be categorized. Categories may define a top level of the hierarchical data structure 602. Categories may include, for example, Entities, Underwriting, Collateral, Terms and Provisions, Regulatory, Administrative, and/or other categories.

The hierarchical data structure provides a single data schema for documenting transactions between a customer and a financial institution throughout a variety of localities, allowing single integration of transaction information regardless of local practices. The single integration allows for a financial institution or other party integrating to the data schema to originate consumer loans, commercial loans, portfolio mortgages, conforming mortgages, home equity loans, deposit accounts, retirement or other tax favored deposit accounts, and/or other transactions without the need for multiple, expensive and time-intensive integrations. For example, via the use of roles, data identifying parties to a transaction may be mapped to by the integrating party only once. Thereafter, the same data may be used within all areas of the financial institutions simply by applying different roles and uses to the same data and associating via ID references.

In some implementations of the invention, a collection of unpopulated (i.e., does not include transaction information) transaction documents that potentially may be used in one or more transactions (i.e., potential transaction documents) are gathered in a knowledge base. Generally speaking, these potential transaction documents correspond to legally compliant transaction documents maintained by an entity in accordance with various local, state and/or federal rules, regulations, and/or policies. By maintaining these potential transaction documents in the knowledge base and modifying them as changes occur in such rules, regulations and policies, the entity may warrant and/or guarantee to users that transaction papered by such potential transaction documents comply with the rules, regulations and/or policies.

In some implementations of the invention, the potential transaction documents correspond to program code that, when executed on a computer or other processor, render a transaction document. In some implementations of the invention, this program code may correspond to a markup language such as XML or other markup language as would be appreciated. According to various implementations of the invention, potential transaction documents include one or more potential “associations” built into such program code that relate the potential transaction document to one or more entities and/or one or more items of collateral for a transaction. During a document selection process (where various ones of the potential transaction documents are selected for a particular transaction), these “associations” get linked to specific transaction information. These “associations” correspond to an abstraction between an actual transaction document and the underlying transaction information that ultimately populates the actual transaction document for a transaction. In various implementations of the invention, the potential transaction document specifies one or more types and/or sub-types of “association” for the potential transaction document and a maximum number of each type and/or sub-type for the potential transaction document.

During the rendering of the transaction documents, the “associations” are resolved to populate the transaction documents with transaction information (e.g., actual data corresponding to parties or items of collateral for the transaction) from uniform hierarchical information 112 based on the specified roles. In addition, the “associations” may also control a number of copies of a particular transaction document based on relationships defined in the “associations” and the specified roles.

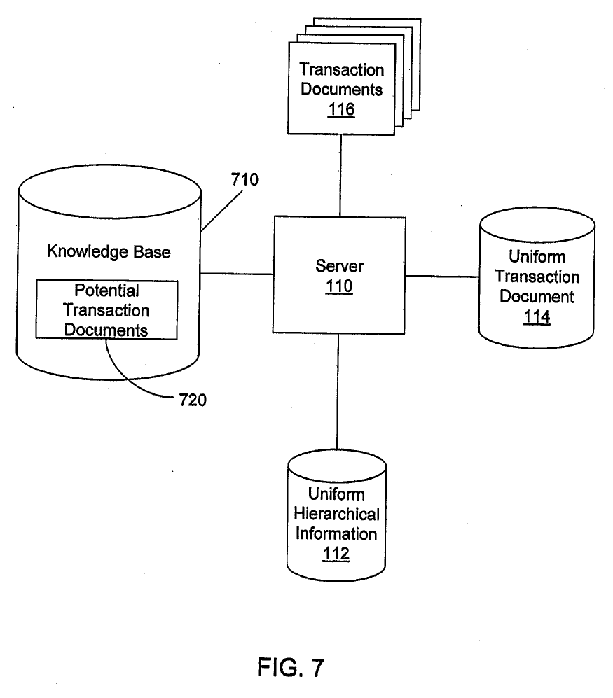

FIG. 7 illustrates a transaction document generation system 700 (“system 700”) that may be used to generate transaction documents 116 in accordance with various implementations of the invention. System 700 includes a knowledge base 710 which in turn includes a plurality of potential transaction documents 720. In some implementations of the invention, potential transaction documents 720 correspond to electronic transaction documents that have been constructed to operate with uniform hierarchical information 112 as discussed herein. Knowledge base 710 and the potential transaction documents 720 included therein are designed to facilitate changes in transactions and legal requirements associated with such transactions. As described above, in various implementations of the invention, the potential transaction documents 720 may include one or more potential “associations” that relate the potential transaction document 720 with one or more entities and/or one or more items of collateral that exist in a particular transaction. As described herein, the entities and/or the items of collateral are specified in uniform hierarchical information 112. When transaction documents 116 are rendered for a particular transaction, the “associations” are resolved and the transaction documents are populated with transaction information 106 corresponding to the entities and/or items of collateral from uniform hierarchical information 112.

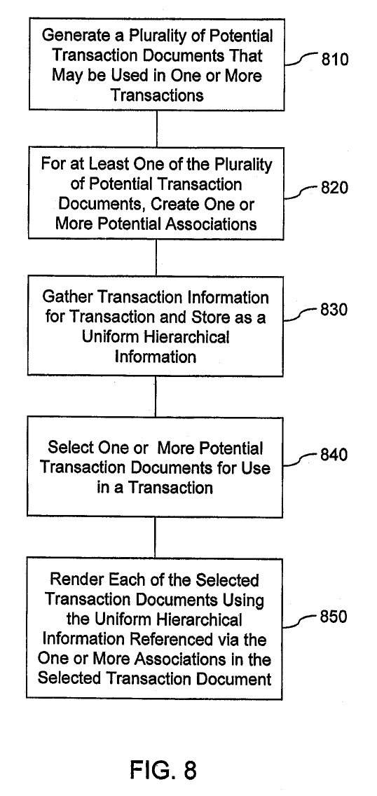

FIG. 8 illustrates a process for generating transaction documents 116 in accordance with various implementations of the invention. In an operation 810, a plurality of potential transaction documents 720 that may be used in one or more transactions is generated. In various implementations of the invention, this plurality of generated potential transaction documents 720 is stored in knowledge base 710. In an operation 820, the plurality of potential transaction documents 720 may be constructed to include various potential “associations” that ultimately may be used to relate the potential transaction document 720 to one or more entities and/or one or more items of collateral available for a particular transaction. In an operation 830, transaction information 106 is gathered for a particular transaction to be papered and stored as uniform hierarchical information 106 in accordance with various implementations of the invention.

In an operation 840, one or more of the potential transaction documents 720 necessary for papering the transaction are identified, selected and used to build uniform transaction document 114. In some implementations of the invention, this selection process depends on uniform hierarchical information 112 as would be appreciated. During this operation, the associations in the selected transaction documents are linked to transaction information corresponding to the one or more entities and/or the one or more items of collateral in uniform hierarchical information 112.

In an operation 850, transaction documents 116 are rendered from uniform transaction document 114. During this operation, the “associations” in the selected transaction documents 720 are resolved so that transaction documents 116 are populated with transaction information 106 corresponding to the one or more entities and/or the one or more items of collateral.

A relevant portion of an exemplary specification and corresponding explanation for potential transaction documents 720 including “associations” is set forth below:

```
<document id=“. . . ”>
    <title>. . . </title>
    <filename>. . . </filename>
    <warranty>. . . </warranty>
    <addendum repeatfirstentry=“true|false”
                selectifzerocount=“true|false”>. . . </addendum>
    <categories>
    <category [subcategory=“. . . ”]>
                        application|ucc|promissoryNote|
            resolution|securityInstrument|landTrust</category>
        . . .
    </categories>
    <combinabledatapoints>
        <datapointname groupcode=“. . . ”>datapoint
                name</datapointname>
        . . .
    </combinabledatapoints>
    <selectionlevel>transaction|account|entity|eventOption|
                          collateral</selectionlevel>
    <associations>
        <association [groupcode=“entity|collateral|
                        specialEntity|supportingEntity”
                          [maxgroupcount=“. . . ”]]>
        primaryTin|account|activity|eventOption|entity|{entity
    type ID}|
            {collateral type ID}|{special entity
    type}|{supporting entity role}
        </association>
        . . .
    </associations>
</document>
```

Sub-elements of the document element include the following:

title General form title

filename Name of the file at the time it was compiled

warranty Warranty information for the file

formversion Version number of the file

addendum (optional element) Document ID of the addendum to this document. The repeatfirstentry attribute indicates if the first entity associated with the document should be repeated on addendums. The selectifzerocount attribute indicates that the document should remain selected even if the special entity count value is zero.

categories (optional element) List of categories in which the document fits. This element is typically used only for Lending documents. Typically, the subcategory attribute is used with the securityInstrument and landTrust categories. It indicates the type of security instrument. The landTrust subcategories define what associations are to be included when a land trust document is selected. The subcategories are defined as follows:

| Subcategory | Included Associations |
|---|---|
| level 1 | land trust, collateral |
| level 2 | land trust |
| level 3 | land trust, collateral, collateral owners |
| level 4 | land trust collateral owners |

Note that these rules typically apply when a land trust is associated with the selected document. Note that a joint application document is designated by a category of application and an entity association maxgroupcount of 2 (or more).

combinabledatapoints (optional element) List of datapoint names that may be used as additional criteria when determining whether or not an association (e.g., collateral) can be combined on the document. In other words, when multiple associations are being combined onto a single document, then the value for the combinable datapoint should match for each related association. For example, the name of the company that is insuring each piece of collateral should match. The groupcode attribute is used to indicate to which grouping the datapoint is relevant. Combinable datapoints have a usage type of optional.

selectionlevel Level at which the document is selected. Note that a value of transaction indicates loan-level for Lending document selection and primary TIN-level for Deposit document selection.

associations (optional element) A list of items (ie: account, entity, collateral, etc.) that are associated with the document when it is selected. This information is closely tied to the selectionLevel value, especially for Lending. For example, if a document calls for a borrower association, then the document is considered to be “borrower-level”. The groupcode attribute indicates the type of association and that the association may potentially be grouped with other associations that have the same group code. For a given group code, only certain association values are allowed. For example, a group code value of collateral indicates that the association value must be a collateral type ID. For a groupcode value of entity, the following association values are valid: primaryTin, entity, collateralOwner, borrower, cosigner, guarantor, hypothecator, subordination, signingEntity. Note that PrimaryTin and entity are DepositAssociationType values. The maxgroupcount attribute indicates the maximum number of associations, with the same groupcode (or same association value if no groupcode is provided), that can be grouped together. However, when the groupcode is specialEntity, the maxgroupcount attribute applies to the specific special entity type, not the entire group. When the groupcode is Entity, the maxgroupcount attribute for the signingEntity type is viewed separate from the other entity types. A value of zero or the absence of this attribute indicates that there is no maximum. A maxgroupcount value of 2 for borrower entities on a lending application document indicates that joint applicants are allowed. A maxgroupcount value greater than 1 for collateral associations indicates that the document allows collateral to be combined. If an association is defined for more that one entity type or collateral type, it means that the document, when selected, gets associated with one of the listed types, not all of them. The special entity type is used in conjunction with the sepecialEntity group code and is used as a link to the datapoint dictionary, where a “count” datapoint is defined with a datatypename that matches a specific special entity type (eg: the special entity type is used to determine the datapoint name). Special entities are primarily used for Lending document selection. Special entity types include:
numPoas.A, numDepositVerifications.D, numAssignDairyProducts.E, numPersonalFinancialStatements.F, numExecutiveOfficerAgreements.I, numParticipationAgreements.J, numLoanVerifications.L, numPotentialBuyers.P, numPaymentsAssigned.Q, numEmployerVerifications.R, totalAssetCount.T, and totalLiabilityCount.Y,
   where the suffix represents the code that is used to create the special entity IDs that are associated with the selected document. Even though special entity datapoint values are not used to select a document (they are used to select addendums), all relevant special entity datapoints should be referenced in the document's selection script in order to put the datapoint into play. For a groupcode value of supportingEntity, the association value is the role (e.g., a role in a TXL file) of an entity that is not used to select a document, but may be assigned as an association. The role used here should drive or supplement the entity's role in the transaction rather than the other way around. This groupcode is intended to replace specialEntity.

As used herein, the term “document” may include any electronic record (such as a database record, electronic file, etc.), written record (such as a paper instrument, note, etc.), or other suitable medium for recording information related to transactions 102. Furthermore, unless specifically expressed otherwise, use of singular is intended to be plural and vice versa. For example, “document” and “documents” may be used interchangeably.

Various implementations of the invention may be made in hardware, firmware, software-enabled hardware, or any suitable combination thereof. Various implementations of the invention may include software instructions stored on a computer readable medium, which may be read and executed by one or more processors. A computer readable medium may include any tangible mechanism for storing or transmitting information in a form readable by a machine (e.g., a computing device). For example, a computer readable medium may include read only memory, random access memory, magnetic disk storage media, optical storage media, flash memory devices, and other tangible medium. Further, firmware, software, routines, or instructions may be described in the above disclosure in terms of specific exemplary aspects and implementations of the invention, and performing certain actions. However, it will be apparent that such descriptions are merely for convenience and that such actions in fact result from computing devices, processors, controllers, or other devices executing the firmware, software, routines, or instructions.

Aspects and implementations may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other aspects or implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A computer-implemented method for generating a transaction document used in a transaction, the method comprising:
generating a plurality of potential transaction documents, wherein at least one of the plurality of potential transaction documents is to be used in the transaction;
creating one or more associations that relate the at least one of the plurality of potential transaction documents to transaction information used in the transaction;
receiving the transaction information and storing the transaction information in a uniform hierarchical format;
selecting the at least one of the plurality of potential transaction documents for use in the transaction; and
rendering the transaction document based on the transaction information in the uniform hierarchical format, the one or more associations, and the selected at least one of the plurality of potential transaction documents.

2. The method of claim 1, wherein the transaction information includes one or more entities associated with the transaction or one or more collateral associated with the transaction, and wherein the one or more associations relate the at least one of the plurality of potential transaction documents to the one or more entities or the one or more collateral.

3. The method of claim 1, wherein the at least one of the plurality of potential transaction documents is necessary for the transaction.

4. The method of claim 3, wherein the at least one of the plurality of potential transaction documents is a necessary document for compliance with at least one government rule, regulation, or policy.

5. The method of claim 1, wherein said selecting is based on a content of the transaction information in the uniform hierarchical format or a type of the transaction to be papered.

6. The method of claim 1, further comprising:
selecting a second one of the plurality of potential transaction documents for use in the transaction, and wherein said rendering is further based on the second one of the plurality of potential transaction documents.

7. The method of claim 1, further comprising:
storing the plurality of potential transaction documents in a knowledge base, wherein the knowledge base is used to store documents to be potentially used in a plurality of types of transactions.

8. A computer readable medium for generating a transaction document used in a transaction, the computer readable medium having instructions stored thereon that when executed on one or more processors configure the one or more processors to:
generate a plurality of potential transaction documents, wherein at least one of the plurality of potential transaction documents is to be used in the transaction;
create one or more associations that relate the at least one of the plurality of potential transaction documents to transaction information used in the transaction;
receive the transaction information and store the transaction information in a uniform hierarchical format;
select the at least one of the plurality of potential transaction documents for use in the transaction; and
render the transaction document based on the transaction information in the uniform hierarchical format, the one or more associations, and the selected at least one of the plurality of potential transaction documents.

9. The computer readable medium of claim 8, wherein the transaction information includes one or more entities associated with the transaction or one or more collateral associated with the transaction, and wherein the one or more associations relate the at least one of the plurality of potential transaction documents to the one or more entities or the one or more collateral.

10. The computer readable medium of claim 8, wherein the at least one of the plurality of potential transaction documents is necessary for the transaction.

11. The computer readable medium of claim 10, wherein the at least one of the plurality of potential transaction documents is a necessary document for compliance with at least one government rule, regulation, or policy.

12. The computer readable medium of claim 8, wherein said selection is based on a content of the transaction information in the uniform hierarchical format or a type of the transaction to be papered.

13. The computer readable medium of claim 8, the instructions when executed further configuring the one or more processors to:
select a second one of the plurality of potential transaction documents for use in the transaction, and wherein said render the transaction document is further based on the second one of the plurality of potential transaction documents.

14. The computer readable medium of claim 8, the instructions when executed further configuring the one or more processors to:
store the plurality of potential transaction documents in a knowledge base, wherein the knowledge base is used to store documents to be potentially used in a plurality of types of transactions.

15. A system for generating a transaction document used in a transaction, comprising:
one or more processors configured to:
generate a plurality of potential transaction documents, wherein at least one of the plurality of potential transaction documents is to be used in the transaction;
create one or more associations that relate the at least one of the plurality of potential transaction documents to transaction information used in the transaction;
receive the transaction information and store the transaction information in a uniform hierarchical format;
select the at least one of the plurality of potential transaction documents for use in the transaction; and
render the transaction document based on the transaction information in the uniform hierarchical format, the one or more associations, and the selected at least one of the plurality of potential transaction documents.

16. The system of claim 15, wherein the transaction information includes one or more entities associated with the transaction or one or more collateral associated with the transaction, and wherein the one or more associations relate the at least one of the plurality of potential transaction documents to the one or more entities or the one or more collateral.

17. The system of claim 15, wherein the at least one of the plurality of potential transaction documents is necessary for the transaction.

18. The system of claim 17, wherein the at least one of the plurality of potential transaction documents is a necessary document for compliance with at least one government rule, regulation, or policy.

19. The system of claim 15, wherein said selection is based on a content of the transaction information in the uniform hierarchical format or a type of the transaction to be papered.

20. The system of claim 15, the one or more processors further configured to:
select a second one of the plurality of potential transaction documents for use in the transaction, and wherein said render the transaction document is further based on the second one of the plurality of potential transaction documents.

21. The system of claim 15, the one or more processors further configured to:
store the plurality of potential transaction documents in a knowledge base, wherein the knowledge base is used to store documents to be potentially used in a plurality of types of transactions.
